(19) United States
(12) Patent Application Publication
(10) Pub. No.: US 2015/0338318 A1
(43) Pub. Date: Nov. 26, 2015

(54) ASSEMBLY FOR MONITORING CONTAMINANT PARTICLES IN LIQUID FLOW

(71) Applicant: GASTOPS LTD., Ottawa (CA)

(72) Inventors: Kevin GODDARD, Cumberland (CA); Steve RODGER, Kars (CA)

(73) Assignee: GasTOPS Ltd., Ottawa, ON (CA)

(21) Appl. No.: 14/761,058

(22) PCT Filed: Jan. 15, 2014
(86) PCT No.: PCT/CA2014/000023

§ 371 Date: Jul. 15, 2015

Related U.S. Application Data
(60) Provisional application No. 61/753,069, filed on Jan. 16, 2013.

(51) Int. Cl. G01N 1/20; B01D 21/26; B01D 21/00

(52) U.S. Cl. CPC G01N 1/20; B01D 21/0012; B01D 21/267

(57) ABSTRACT

An assembly for monitoring a liquid potentially containing contaminant particles flowing through a conduit that may include a swirl inducer for inducing swirl flow within the conduit to cause contaminant particles to migrate toward the periphery of the conduit. A removable plug defines a passage for coupling into the path of the peripheral fluid flow within the conduit. A device associated with the removable plug senses sensing or captures in situ the contaminant particles such that the captured contaminant particles can be accessed by removing the plug.

This application claims the benefit of U.S. Provisional application Ser. No. 61/753,069 filed on Jan. 16, 2013 and incorporated by reference herein.

### FIELD OF THE INVENTION

This invention relates to the monitoring of contaminant particles in liquid flow, for example in oil flow in an engine, particularly, but not exclusively, turbine engines, such as are used in aircraft.

### BACKGROUND OF THE INVENTION

Oil is the lifeblood of an engine or more generally any rotating machinery, and it is vital to maintain its quality in order to avoid serious damage to the machinery. Moreover, the presence of contaminant particles in the oil indicates the presence of wear and is a strong indicator of potential failure of the engine. The nature of the contaminant particles can provide a lot of useful information about the condition of the engine, and the location and nature of any potential failure.

It is known to employ sensors, such as magnetic chip detectors, on the oil lines within the engine, and these are good at detecting the presence of metal particles, but they do not detect non-metallic particles, and also do not provide information about the nature of the particles. These sensors also have a low capture efficiency (<15%) and only capture ferrous particles.

U.S. Pat. No. 4,834,887 describes an oil separation system where a swirl flow is induced in a pipe to separate denser higher density fluids using centrifugal separation.

### SUMMARY OF THE INVENTION

According to one aspect of the present invention, there is provided an assembly for monitoring a liquid potentially containing contaminant particles flowing through a conduit, comprising: a swirl inducer for inducing swirl flow within the conduit to cause contaminant particles to migrate toward the periphery of the conduit; a removable plug with a transverse bore for coupling into the path of liquid within the conduit; and a perforated screen located in said transverse bore for capturing in situ the contaminant particles flowing in a peripheral region of the conduit.

Typically the conduit will be an oil line in an engine. However, the invention is potentially also applicable to other situations where a contaminant-containing liquid flows through a pipe, for example a hydraulic line, or in other types of rotating machinery.

The removable plug can be inserted directly into a radial bore in the oil line, but it can also be inserted into a bore in a housing mounted on the oil line. In this case, the peripheral oil flow is directed into the passage in the housing with a redirector located in the oil line.

The swirl inducer may be a streamlined body with helical vanes inserted in the conduit to induce helical flow. The helical flow creates a centrifugal action, which in turn causes particles within the liquid to migrate toward the periphery of the pipe.

In one embodiment, the particles are collected in a removable screen. In another embodiment, they are sensed using an electronic sensor. In the latter case, the fact that the particles concentrate in the periphery of the pipe close to where the sensor is located in effect makes the sensor more sensitive. The sensor may be mounted on the removable plug, although in another embodiment it may be mounted directly on the oil line as in the case of a conventional electronic sensor. In this case, the concentration of contaminants at the periphery of the line increases the sensitivity of the sensor as noted above.

In another aspect of the invention there is provided an assembly for sensing contaminant particles in a liquid flowing through a conduit, comprising: a swirl inducer for inducing swirl flow within the conduit to cause contaminant particles to migrate toward the periphery of the conduit; and a non-invasive electronic particle sensor for sensing the contaminant particles in the peripheral flow within the conduit.

In yet another aspect the invention comprises a removable plug for insertion into a radial bore in an oil line, comprising: a body with transverse bore for alignment with the interior of the oil line; and an annular removable perforated screen located in the transverse bore for capturing contaminant particles in the peripheral flow within the oil line and permitting central flow unobstructed within the oil line to pass through a central opening defined by the annular perforated screen.

### BRIEF DESCRIPTION OF THE DRAWINGS

The invention will now be described in more detail, by way of example only, with reference to the accompanying drawings, in which:—

FIG. 1 is a cross sectional view of a portion of an engine oil line including an assembly in accordance with an embodiment of the invention;

FIG. 2A is an end view of a detail of the assembly shown in FIG. 1;

FIG. 2B shows a detail in sectional view of FIG. 2A; and

FIG. 3 is a crossectional view of an engine oil line showing a second embodiment of the invention.

### DETAILED DESCRIPTION OF EMBODIMENTS OF THE INVENTION

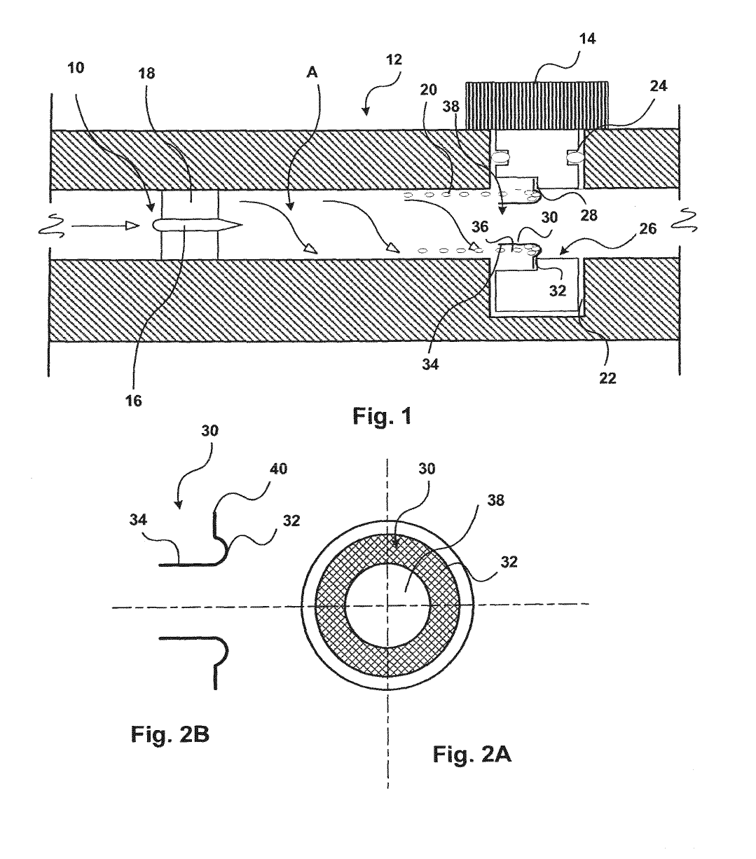

The assembly shown in FIG. 1 comprises a swirl inducer 10 mounted within an oil line 12 forming part of a turbine engine (not shown) upstream of a removable radial plug 14 inserted in the oil line 12.

The swirl inducer 10 comprises a streamlined body 16 retained within the oil line 12 by helical vanes 18. As the oil within the line flows over the swirl inducer 10, the helical vanes 18 induce a rotational or swirl motion in the oil, which in turn causes contaminant particles 20 to concentrate near the periphery of the oil line as a result of centrifugal action.

The removable plug 14 is inserted in a radial bore 22 with a blind end in the oil line and retained in place by a twist-lock mechanism (not shown), for example, of the bayonet type. A seal 24 prevents the oil in the line from escaping from the oil line when the plug 14 is in place. The plug can be removed when the engine is not running with minimal loss of oil from the line 12.

The radial bore 22 and plug 14 may also incorporate a self-sealing mechanism to prevent oil leakage when the plug is removed from the oil line.

The removable plug 14 includes a transverse bore 26, which when the plug is in place inserted into the bore 22, is in alignment with the oil line 10 so that the oil normally flows through the transverse bore.

The plug 14 also includes an annular recess defining a shoulder 28, which accommodates a removable insert 30 with an annular perforated screen 32 having a tubular portion 34 facing the oil flow. The tubular portion defines with the transverse bore 26 a peripheral passage 36 through which the peripheral portion of the oil flows. After passing through the perforated screen 32 leaving the contaminant particles 20 behind, this peripheral flow joins the main flow in the oil line.

Meanwhile the main central flow passes through the central opening 38 in the insert 30 and merges with the peripheral flow downstream of the insert 30. The use of the annular screen with the central opening reduces the risk of clogging the oil line as even if the perforated screen becomes clogged with particles in the peripheral flow, the oil is still free to pass through the central opening 38

As shown in FIG. 2B, the tubular portion 34 merges at the downstream end into the annular concave perforated screen 32. This in turn is surrounded by a radial retaining lip or flange 40, which abuts against the shoulder 28 formed by the recess surrounding the transverse bore 26 in the plug 14.

The removable plug 14 is fitted at a convenient accessible location within the engine. During normal use, the assembly minimally interferes with the oil flow and operation of the engine. The swirl inducer 10 causes contaminant particles in the oil migrate to the periphery of the line and become trapped by the insert 30.

Periodically, when the engine is stopped, the plug may be removed, and the insert replaced. This operation can be performed very rapidly, thus ensuring minimum disruption to engine operations. The particles on the screen can then be examined as to quantity, size and composition using conventional analytic techniques.

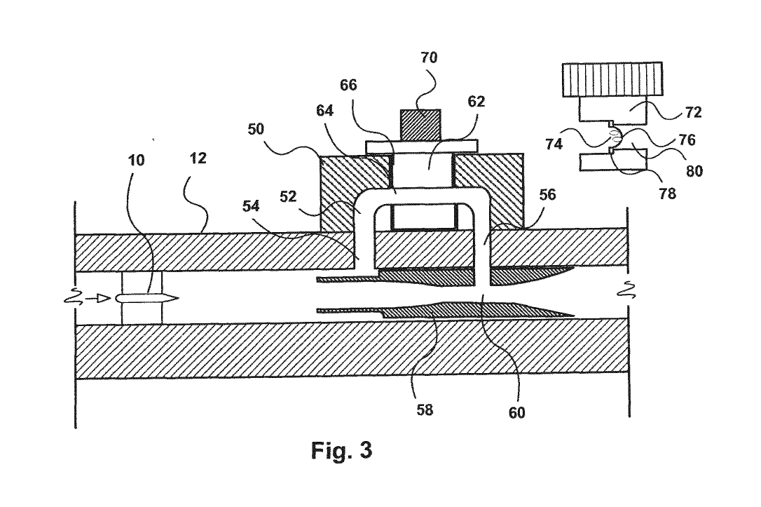

An alternative embodiment is shown in FIG. 3. In this embodiment, a housing 50 containing a passage 52 through which the peripheral oil flows is mounted externally on the oil line 12. The passage 52 is coupled to inlet and return radial bores 54, 56 in the oil line 10. An annular guide 58 with a restriction 60 defining a Venturi in the vicinity of the return bore 56 is located within the oil line 12.

A removable plug 62 with a twist-lock mechanism is inserted in a radial bore 66 formed in the housing 50. The plug 62 has a transverse bore 64, which when the plug is inserted in the housing 50, is aligned with the passage 52.

As the oil flows through the line 12, the peripheral oil is directed by the guide 58 into the inlet bore 54 and through the passage 52 and transverse bore 64, returning through the return bore 56. The presence of the Venturi tends to reduce the pressure in the main oil line 12 in the region of the return bore 56, thus encouraging the return flow of oil into the main line 12.

In this embodiment, an electronic particle sensor 70 is mounted on the cap of the plug 62 and integrated therewith. As the contaminant particles concentrate in the peripheral flow, they are closer to the sensor, and thus the sensitivity of the sensor is improved.

In an alternative embodiment, the sensor could be mounted directly on the exterior of the oil line. In this case, the concentration of particles in the peripheral flow will still enhance the sensitivity of the sensor.

In a variation of the embodiment shown in FIG. 3, the oil plug 70 with the integrated sensor can be replaced by a capture plug 72. This operates in a manner similar to the embodiment shown in FIG. 1 except that the insert 74 is in the form of a concave cup with perforated screen and retaining lips 78 that abut shoulders formed in the transverse bore 80. In this case all the oil flowing through the passage 52, which already represents the peripheral flow in the main oil line 12, flows through the screen 76.

Embodiments of the invention thus provide a convenient way of monitoring the build-up of contaminants in an engine that is minimally invasive and does not require draining of the oil sump. The concentration of particles in the peripheral flow caused by the swirl motion of the oil also enhances the effect of the sensor.

As noted, although primarily applicable to engine systems, embodiments of the invention have applicability in other areas, such as monitoring hydraulic lines.

1. An assembly for monitoring a liquid potentially containing contaminant particles flowing through a conduit, comprising:
a swirl inducer for inducing swirl flow within the conduit to cause contaminant particles to migrate toward the periphery of the conduit;
a removable plug with a transverse bore for coupling into the path of liquid within the conduit; and
a perforated screen located in said transverse bore for capturing in situ the contaminant particles flowing in a peripheral region of the conduit.

2. An assembly as claimed in claim 1, wherein the perforated screen is annular and removably located in said transverse bore.

3. An assembly as claimed in claim 2, wherein the removable plug is adapted to fit in a radial bore in the conduit with said transverse bore being aligned with the interior of the conduit.

4. An assembly as claimed in claim 3, wherein and the perforated screen forms part of an insert with a tubular portion defining with the transverse bore a passage guiding peripheral liquid to the perforated screen.

5. An assembly as claimed in claim 4, wherein a shoulder is formed in the wall of said transverse bore to retain a lip forming part of the insert.

6. An assembly as claimed in claim 1, further comprising a sensor mounted externally of the conduit to sense the presence of detectable particles within the conduit.

7. An assembly as claimed in claim 1, comprising a housing mountable on the exterior of the conduit and containing a passage for coupling to the interior of the conduit through inlet and return radial bores in the conduit so that peripheral liquid flows through the passage in the housing, and the housing having a radial bore for accommodating the removable plug, the removable plug having a transverse bore for alignment with the passage in the housing.

8. An assembly as claimed in claim 7, comprising a removable perforated screen inserted in the axial bore of the plug.

9. An assembly as claimed in claim 7, further comprising is a particle sensor located on the removable plug.

10. An assembly as claimed in claim 7, further comprising an annular guide mountable within the conduit for directing peripheral liquid flow into the passage in the housing.

11. An assembly as claimed in claim 10, wherein the annular guide defines an interior Venturi for the central liquid flow.

12. An assembly as claimed in claim 1, wherein the swirl inducer comprises a streamlined body with a plurality of radial swirl vanes.

13. A removable plug for insertion into a radial bore in an oil line, comprising:
a body with transverse bore for alignment with the interior of the oil line; and
an annular removable perforated screen located in the transverse bore for capturing contaminant particles in the peripheral flow within the oil line and permitting central flow unobstructed within the oil line to pass through a central opening defined by the annular perforated screen.

14. A removable plug as claimed in claim 12, wherein the annular perforated removable screen forms part of an insert having a retaining lip located in a peripheral recess in said transverse bore.

15. An assembly for sensing contaminant particles in a liquid flowing through a conduit, comprising:
a swirl inducer for inducing swirl flow within the conduit to cause contaminant particles to migrate toward the periphery of the conduit; and
a non-invasive electronic particle sensor for sensing the contaminant particles in the peripheral flow within the conduit.

16. A method of monitoring liquid flow in a conduit, comprising:
inducing a swirl motion in the liquid flowing within the conduit to cause contaminant particles to migrate to the periphery of the conduit; and
capturing in situ or sensing the contaminant particles in the peripheral flow.

17. A method as claimed in claim 16, wherein the particles are captured in situ in a plug that can be removed to access the captured particles.
